(19) United States
(12) Patent Application Publication
(10) Pub. No.: US 2023/0246408 A1
(43) Pub. Date: Aug. 3, 2023

(54) HOLMIUM-DOPED FIBER AMPLIFIER WITH EFFICIENT LOW COST CASCADED FIBER LASER PUMPING AND A METHOD THEREFOR

(71) Applicant: OPTIWAVE SYSTEMS INC., Ottawa (CA)

(72) Inventors: Ahmad Atieh, Ottawa (CA); Muhammad Jawad Mirza, Islamabad (PK); Salman Abdul Ghafoor, Islamabad (PK)

(21) Appl. No.: 18/092,187

(22) Filed: Dec. 30, 2022

Related U.S. Application Data
(60) Provisional application No. 63/305,190, filed on Jan. 31, 2022.

(51) Int. Cl. H01S 3/094; H01S 3/16; H01S 3/067; H01S 3/0941; H01S 3/23

(52) U.S. Cl. CPC H01S 3/094003; H01S 3/161; H01S 3/1608; H01S 3/1616; H01S 3/06754; H01S 3/0941; H01S 3/094042; H01S 3/23

(57) ABSTRACT

A Holmium-doped fiber amplifier (HDFA) with cascaded pumping is disclosed. The cascaded pumping has at least two pumping stages arranged so that an emission spectrum of a preceding pumping stage at least partly corresponds to an absorption spectrum of the succeeding pumping stage, and the pumping stages are staggered so that an emission spectrum of the last pumping stage at least partly corresponds to an absorption spectrum of the Holmium-doped fiber.

### CROSS-REFERENCE TO RELATED APPLICATIONS

The present application claims the benefit of the U.S. provisional application Ser. No. 63/305,190 filed Jan. 31, 2022, the entire contents of which are incorporated herein by reference.

### FIELD OF THE INVENTION

The present invention generally relates to doped fiber amplifiers, and in particular to a Holmium-doped fiber amplifier with an efficient low cost cascaded fiber laser pumping and a method therefor.

### BACKGROUND OF THE INVENTION

Over the past decade, the demand for high-speed and high-data rate transmission systems have increased tremendously due to proliferation of various technologies such as Internet of Things (IoTs), high-definition online streaming, video gaming, video conferencing, social media platforms, VoIP etc. With the development of various bandwidth intensive Internet applications, the need of more and more bandwidth continues to increase. Consequently, the transmission capacity of optical fiber networks have enormously increased during the past few years to accommodate the significant increase in bandwidth demand. The commercially deployed wavelength division multiplexed (WDM) networks transporting more than 160 channels having aggregate data rate of around 1.6 Tb/s over a single fiber operate in C-band (1.53-1.565 μm) have been demonstrated. Also the development of Erbium-doped fiber amplifiers (EDFAs) operating in extended L-band (1.565-1.62 μm) and U-band (1.62 to 1.67 μm) has further increased the transmission capacity of WDM networks.

Recently, an optical window around 2 μm has been getting attention for future optical communication systems as an extension to the C-, L-, and U-bands, and the research has been booming to find corresponding optical amplifiers with high gain and low noise levels.

Holmium-doped fiber amplifier (HDFA) operating in the 2 μm optical window appears to be a suitable candidate, however a pump laser for exciting the HDFA is expensive and not widely available, which makes a commercial use of the HDFA problematic.

Therefore, there is a need in the industry for developing an HDFA with an alternative and/or improved pumping, which would address or mitigate the above noted problems.

### SUMMARY OF THE INVENTION

There is an object of the present invention to develop a Holmium-doped fiber amplifier with efficient lost cost cascaded fiber laser pumping and a corresponding method therefor.

According to one aspect of the invention, there is provided a Holmium-doped fiber amplifier (HDFA), comprising:

a Holmium-doped fiber (HDF); and
a cascaded pumping arrangement for the Holmium-doped fiber, comprising at least two cascaded pumping stages, wherein:

(1) an emission spectrum of a preceding cascaded pumping stage at least partly corresponds to an absorption spectrum of the succeeding cascaded pumping stage; and

(2) the cascaded pumping stages are staggered so that an emission spectrum of the last cascaded pumping stage at least partly corresponds to an absorption spectrum of the Holmium-doped fiber.

In the HDFA described above, the preceding cascaded pumping stage comprises an Erbium-doped fiber (EDF) pumped at one of the 980 nm or 1480 nm, and emitting a first output signal at 1620 nm;

the succeeding cascaded pumping stage comprises a Thulium-doped fiber (TDF) pumped by the first output signal from the EDF at 1620 nm, and emitting a second output signal at 1950 nm; and

the second output signal from the TDF at 1950 nm is used to pump the HDF.

According to another aspect of the invention, there is provided a cascaded pumping arrangement for a Holmium-doped fiber, comprising:

at least two cascaded pumping stages, wherein:

(1) an emission spectrum of a preceding cascaded pumping stage at least partly corresponds to an absorption spectrum of the succeeding cascaded pumping stage; and

(2) the cascaded pumping stages are staggered so that an emission spectrum of the last cascaded pumping stage at least partly corresponds to an absorption spectrum of the Holmium-doped fiber.

In the cascaded pumping arrangement described above, the preceding cascaded pumping stage comprises an Erbium-doped fiber (EDF) pumped at one of the 980 nm or 1480 nm, and emitting a first output signal at 1620 nm;

the succeeding cascaded pumping stage comprises a Thulium-doped fiber (TDF) pumped by the first output signal from the EDF at 1620 nm, and emitting a second output signal at 1950 nm; and

the second output signal from the TDF at 1950 nm is used to pump the HDF.

Thus, we have proposed the Holmium-doped fiber amplifier for amplifying a modulated optical signal in the 2 μm wavelength range, using an efficient and low-cost pumping scheme to excite the gain medium of the HDFA.

The pumping scheme has first and second cascaded fiber laser cavities (stages) using Erbium-doped fiber (EDF) and Thulium-doped fiber (TDF), respectively. The EDF in the first cavity is pumped using a commercial pump laser of 1.48 μm wavelength to create a continuous wavelength (CW) laser at 1.62 μm, which, in turn, is used to pump the TDF in the second cavity. The second cavity creates another CW laser at 1.95 μm, which is used to pump the Holmium-doped Fiber (HDF) accordingly.

The performance of the HDFA is analyzed in detail for various operating conditions. A high small-signal gain of around 52.2 dB is achieved for an input signal power of −30 dBm at 2.32 μm by using 5 W laser pump at 1.48 μm. Similarly, a minimum noise level or noise figure (NF) of 5.58 dB has been observed for the input signal power and wavelength of 0 dBm and 2.032 μm, respectively. Finally, the effect of pair induced quenching (PIQ) on small-signal gain of the amplifier has been also evaluated. A penalty of 18.5 dB has been observed in small-signal gain of HDFA at 2.032 μm.

The proposed design of the HDFA with cascaded pumping has been implemented by using a software named “OptiSystem” for optical communication system design developed by Optiwave Systems Inc. The software has been used for designing the cascaded cavities and optimizing the lengths of the EDF and TDF along with doping concentrations of Er³⁺ and Tm³⁺ ions. The performance of the HDFA has been analyzed, and results are presented below in the following sections of this patent application.

Thus, an improved Holmium-doped fiber amplifier with efficient lost cost cascaded fiber laser pumping and a corresponding method therefor have been provided.

### BRIEF DESCRIPTION OF THE DRAWINGS

The patent or application file contains at least one drawing executed in color. Copies of this patent application publication with color drawing(s) will be provided by the Office upon request and payment of the necessary fee.

Embodiments of the present invention will be further described with reference to the accompanying exemplary drawings, in which:

FIGS. 1A and 1B illustrate absorption and emission spectra, and an energy level diagram for Er³⁺, trivalent Erbium ions, respectively;

FIGS. 1C and 1D illustrate absorption and emission spectra, and an energy level diagram for Tm³⁺, trivalent Thulium ions, respectively;

FIGS. 1E and 1F illustrate absorption and emission spectra, and an energy level diagram for Ho³⁺, trivalent Holmium ions, respectively;

FIG. 2A shows a dependence of the Stimulated Emission (SE) in the EDFA of the first cavity on the length of the EDF, for the pumping power of 1.48 m laser being equal to about 5 W, concentration of Er³⁺ ions at about 40×10²⁴ m⁻³, a coupling ratio between the first and second cavity of about 10%, and a tunable optical filter (TOF) of the first cavity being tuned at 1.62 μm;

FIG. 2B shows a dependence of the Stimulated Emission (SE) in the EDFA in the first cavity on the concentration of Er³⁺ ions, for the pumping power of 1.48 m laser of about 5 W, the length of the EDF of about 17.5 m, a coupling ratio between the first and second cavity of about 10%, and a tunable optical filter (TOF1) of the first cavity being tuned at 1.62 μm;

FIG. 3A shows a dependence of the Stimulated Emission (SE) in the TDFA of the second cavity on the length of TDF, for Tm³⁺ concentration at about 50×10²⁴ m⁻³, a coupling ratio between the second cavity and the HDFA of about 10%, and a tunable optical filter (TOF2) of the first cavity tuned at 1.95 μm;

FIG. 3B shows a dependence of the Stimulated Emission (SE) in the TDFA of the second cavity on the concentration of Tm³⁺ ions, for the length of the TDF of about 6 m, a coupling ratio between the second cavity and the HDFA of about and about 10%, and a tunable optical filter (TOF2) of the first cavity being tuned at 1.95 μm;

FIG. 4 shows a Holmium-doped fiber amplifier of the embodiment of the present invention with an efficient low-cost cascaded fiber laser pumping;

FIG. 5A shows a dependence of the output power from the first cavity versus the center wavelength of the first tunable optical filter TOF1, for output coupling ratios between the first and second cavities of 10%, 20%, and 30% respectively;

FIG. 5B shows a dependence of the output power from the second cavity versus the center wavelength of the second tunable optical filter TOF2, for output coupling ratios between the second cavity and the HDFA of 10%, 20%, and 30% respectively;

FIG. 6A shows an output power, or lasing power, from the first cavity versus a lasing wavelength around 1.62 μm, for the output coupling ratio of 20% between the first and second cavities;

FIG. 6B shows an output power, or lasing power, from the second cavity versus a lasing wavelength around 1.95 μm, for the output coupling ratio of 20% between the second cavity and the HDFA;

FIG. 7A shows a dependence of the gain of the HDFA versus length of the HDFA, for an input signal at 2.032 μm having power of −30 dBm, the doping concentration of Ho³⁺ at 90×10²⁴ m⁻³, while an output coupling ratio between the first and second cavities being adjusted so that to provide a power of about 2 W for 1.95 μm CW laser;

FIG. 7B shows a dependence of the gain of the HDFA versus the doping concentration of Ho³⁺ ions, for the HDF length of 13.6 m, and the input signal at 2.032 μm having power of −30 dBm, while an output coupling ratio between the first and second cavities being adjusted so that to provide a power of about 2 W for 1.95 μm CW laser;

FIG. 8A shows a dependence of the gain of the HDFA versus a wavelength of the input signal, for different powers of the input signal and fixed optimal length of the HDF length and doping concentration of Ho³⁺ ions;

FIG. 8B shows a dependence of the gain of the HDFA versus wavelength of the input signal with and without PIQ (Pair-Induced Quenching), for the pump power of 2 W, the input signal power of −30 dBm, the length of the HDF of about 13.6 m, and a doping concentration of Ho³⁺ ions of about 95×10²⁴ m⁻³ ;

FIG. 9A shows a dependence of the amplified spontaneous emission (ASE) versus a wavelength of the input signal for various pump powers, for an input signal power of −30 dBm at the optimized HDF length of about 13.6 m and a doping concentration of Ho³⁺ ions of about 95×10²⁴ m⁻³; and

FIG. 9B shows a dependence of the noise figure (NF) versus a wavelength of the input signal, for different powers of the input signal of 0 dBm, −15 dBm and −30 dBm respectively, and the pump power of 2 W, the HDF length of about 13.6 m, and a doping concentration of Ho³⁺ ions of about 95×10²⁴ m⁻³.

### DETAILED DESCRIPTION OF THE EMBODIMENTS OF THE INVENTION

### Theoretical Setting

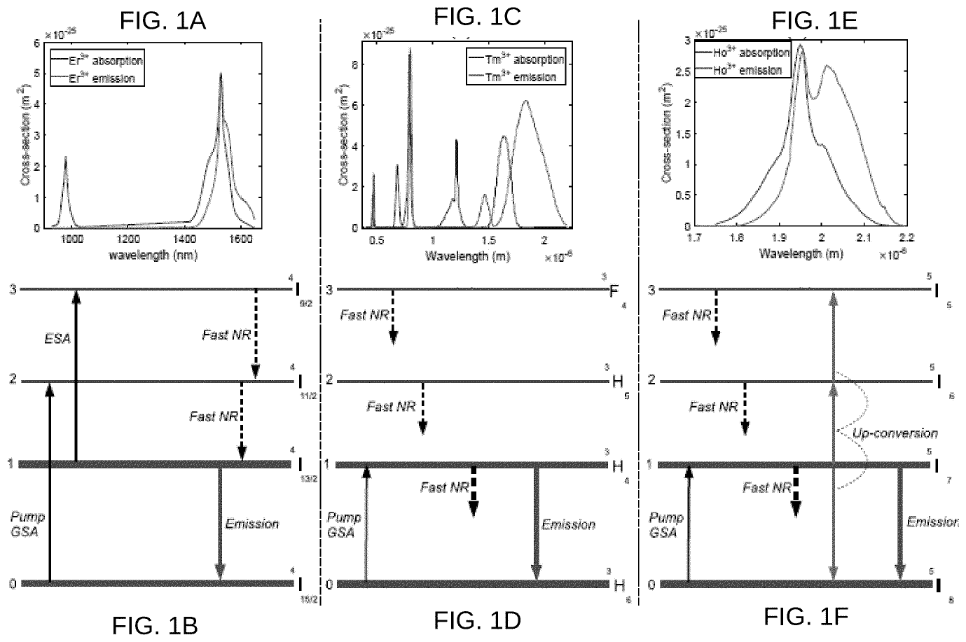

The absorption and emission spectra of Er³⁺, Tm³⁺, and Ho³⁺ have been shown in FIGS. 1A, 1C, and 1E respectively. Corresponding energy level diagrams for Er³′, Tm³⁺, and Ho³⁺ are shown in FIGS. 1B, 1D and 1F respectively. The probability of a dopant ion to absorb a pump photon of a particular wavelength is called absorption cross-section while the emission cross-section is defined as the probability of being existence of an excited ion which will emit a photon after a radiative decay. We have used 1.48 μm laser diode of 5 W to pump the EDF in the first fiber laser. FIG. 1B shows that the ground energy state is ⁴I_{15/2} and first excited state is taken as ⁴I_{13/2}. By in-band pumping the EDF with 1.48 μm laser diode, the transition causing the lasing action at 1.62 μm is I_{15/2}↔4I_{13/2}. Similarly, by assuming that the EDF is homogeneously broadened which is represented by a three-level energy diagram as shown in FIG. 1B because upper two states of fast non-radiative (NR) decay are considered as one, as described for example in W. Yang, Y. Liu, L. Xiao, and Z. Yang, “Wavelength-tunable Erbium-doped fiber ring laser employing an acousto-optic filter,” Journal of Lightwave Technology, vol. 28, no. 1, pp. 118-122, 2010. The reduced rate equations can be written as follows, as described in the above noted paper:

$$\frac{{dN}_{2}}{dt} = \frac{{σ}_{ap}}{{hf}_{p}} {P}_{p} {N}_{1} + \frac{{σ}_{as}}{{hf}_{s}} {P}_{s} {N}_{1} - \frac{\text{?}}{\text{?}} \text{?} {N}_{2} - \frac{{N}_{2}}{τ} \qquad ( 1 )$$

$$\text{?} \text{indicates text missing or illegible when filed}$$

Neglecting the amplified spontaneous emission (ASE) and fiber attenuation, the propagation equations of pump and signal along the EDF in the z-direction can be written as follows:

$$\frac{{dP}_{p}}{dz} = - {Γ}_{p} {σ}_{ap} {N}_{1} {P}_{p} ( z ) \qquad ( 2 )$$

$$\frac{{dP}_{s}}{dz} = - {Γ}_{s} ( {σ}_{as} {N}_{2} - {σ}_{as} {N}_{1} ) {P}_{s} ( z ) \qquad ( 3 )$$

FIG. 1C shows the absorption and emission spectra of Tm3+. It may be observed that although Tm³⁺ has multiple pump absorption peaks resulting into emission at different wavelengths but pumping at 0.793 μm, 1 μm, 1.064 μm, 1.4 μm, 1.57 μm, 1.6 μm, and 1.84 μm is widely employed. In this patent application, 1.62 μm CW laser created in the first cavity is used for in-band pumping the TDF in the second cavity. FIG. 1B shows the energy level diagram of Tm³⁺, where ³H₆ is taken as ground energy state, and ³H₄ is the first excited manifold. The most common transition causing the lasing action at 1.95 μm is ³H₆↔³H₄. Similarly, the rate equations can be written as follows, similar to the equations presented in A. H. M. Husein, and F. I. El-Nahal, “Optimizing the Thulium doped fiber amplifier (TDFA) gain and noise figure for S-band 16×10 Gb/s WDM systems,” Optik, vol. 124, no. 19, pp. 4052-4057, 2013:

$$\begin{matrix}\frac{{dN}_{1}}{dt} = - ( {W}_{10} + \frac{{P}_{p} {σ}_{ap}}{{hf}_{p}} + \frac{{P}_{s} {σ}_{as}}{{hf}_{s}} ) {N}_{1} + {W}_{21} {N}_{2} + \frac{{P}_{s} {σ}_{as}}{{hf}_{s}} \text{?} & ( 4 )\end{matrix}$$

$$\frac{{dN}_{3}}{dt} = \frac{{P}_{s} {σ}_{as}}{{hf}_{s}} {N}_{1} - ( {W}_{30} + \frac{{P}_{p} {σ}_{ap}}{{hf}_{p}} + \frac{{P}_{s} {σ}_{as}}{{hf}_{s}} ) {N}_{3} + \text{?} \text{?} \qquad ( 5 )$$

$$\frac{{dN}_{5}}{dt} = \frac{{P}_{p} {σ}_{ap}}{{hf}_{p}} {N}_{3} + ( {W}_{50} + {W}_{52} ) {N}_{5} \qquad ( 6 )$$

$$\text{?} \text{indicates text missing or illegible when filed}$$

Neglecting the ASE and fiber attenuation, the propagation equations of pump and signal along the TDF in the z-direction can be written as follows:

$$\frac{{dP}_{p}}{dz} = - {Γ}_{p} ( {σ}_{ap} {N}_{0} - {σ}_{ap} {N}_{1} - {σ}_{ap} {N}_{3} ) {P}_{p} ( z ) \qquad ( 7 )$$

$$\frac{{dP}_{s}}{dz} = - {Γ}_{s} ( \text{?} {N}_{3} - {σ}_{as} {N}_{1} - \text{?} \text{?} ) {P}_{s} ( z ) \qquad ( 8 )$$

$$\text{?} \text{indicates text missing or illegible when filed}$$

Finally, FIG. 1E shows the absorption and emission spectra of Ho³. It may be observed that the most commonly used pump wavelength for in-band pumping is around 1.94 μm. The 1.94 μm pump wavelength (corresponding to ⁵I₈↔⁵I₇ transition) is realized by TDFL as shown in FIG. 1F. The energy level diagram of Ho³⁺ is shown in FIG. 1F. The ground energy state is taken as ⁵I₈ manifold while the first excited state is ⁵I₇. The 1.95 μm CW laser created from the second cavity is absorbed at 5I8 manifold, and the transition causing the stimulated emission around 2 μm is ⁵I₈↔⁵I₇. The ion-ion interaction (homogeneous up-conversion, cross relaxation, and pair induced quenching) is a non-radiative energy transfer between a pair of excited Ho³⁴ ions as a result of electric multi-polar interaction which can adversely affect the performance of HDFA, as indicated for example in J. Wang, N. Bae, S. B. Lee, and K. Lee, “Effects of ion clustering and excited state absorption on the performance of Ho-doped fiber lasers,” Optics Express, vol. 27, no. 10, pp. 14283-14297, 2019. Consequently, this interaction results into the transfer of one Ho³⁺ ion to an excited manifold, while the other one is demoted to low energy manifold. There are two up-conversion (UC) processes occurring in the HDF, which may be expressed as UC1 (⁵I₇, ⁵I7↔⁵I₆, ⁵I₈) and UC2 (⁵I₇, ⁵I₇↔⁵I₅, ⁵I₈). Due to very short lifetime of ⁵I₇ manifold, both UCs collectively considered as one. The UCE typically occurs in ion-clusters in fibers having very high doping concentration of Ho³⁺ ions.

The system rate equations are as follows:

$$\frac{{dN}_{0}}{dt} = {W}_{30} {N}_{3} + {W}_{20} {N}_{2} + {W}_{10} {N}_{1} - GSA + SE + UC \qquad ( 9 )$$

$$\frac{{dN}_{1}}{dt} = {W}_{31} {N}_{3} + {W}_{21} {N}_{2} - {W}_{10} {N}_{1} + GSA - SE - 2 UC \qquad ( 10 )$$

The pump absorption or ground state absorption (GSA) and stimulated emission (SE) rates are given by the following expressions, see for example J. Wang, D. Yeom, N. Simakov, A. Hemming, A. Carter, S. B. Lee, and K. Lee, “Numerical modeling of in-band pumped Ho-doped silica fiber lasers,” Journal of Lightwave Technology, vol. 36, no. 24, pp. 5863-5880, 2018:

$$GSA = \frac{{Γ}_{p} {σ}_{ap}}{{hf}_{p}} {N}_{0} {P}_{p} \qquad ( 11 )$$

$$SE = \frac{{Γ}_{s}}{{hf}_{s}} [ {σ}_{as} {N}_{1} - {σ}_{as} {N}_{2} ] {P}_{s} \qquad ( 12 )$$

Similarly, UC rate is given by the following expression:

The propagation equations of pump and signal along the HDF in the z-direction may be written as:

$$\frac{{dP}_{p}}{dz} = - {Γ}_{p} {σ}_{ap} {N}_{0} {P}_{p} ( z ) \qquad ( 14 )$$

$$\frac{{dP}_{s}}{dz} = {Γ}_{s} ( {σ}_{es} {N}_{1} - {σ}_{as} {N}_{0} ) {P}_{s} ( z ) \qquad ( 15 )$$

TABLE 1
Different symbols used in Eq. 1-15

| Symbol | Description |
|---|---|
| Nᵢ, | Population densities at different levels |
| Pₚ, Pₛ | Pump and signal powers |
| hfₚ, hfₛ | Pump and signal photon energies |
| σₐₚ, σₐₛ | Absorption cross-section of the pump and signal |
| σₑₛ | Emission cross-section of signal |
| σ [symbol] | Transition cross-section from background level to first excited |
| | level [symbol] |
| τ | Lifetime of the metastable state |
| Γₚ, Γ [symbol] | Overlap integral of pump and signal |
| Wᵢⱼ | Radiative transition rates from level i to level j |
| h | Plank′s constant |

[symbol]

indicates data missing or illegible when filed

### Optimization of Cascaded Cavities

The doped fiber length and doping concentration are two important parameters which need to be optimized in both cascaded cavities in order to optimally operate the HDFA of the embodiment of the present invention. Therefore, first of all we optimize the first cavity by optimizing the EDF length and doping concentration of Er³⁺. Then, we optimize the second cavity by optimizing the TDF length and doping concentration of Tm³⁺, while taking into account the results of the optimization of the first cavity.

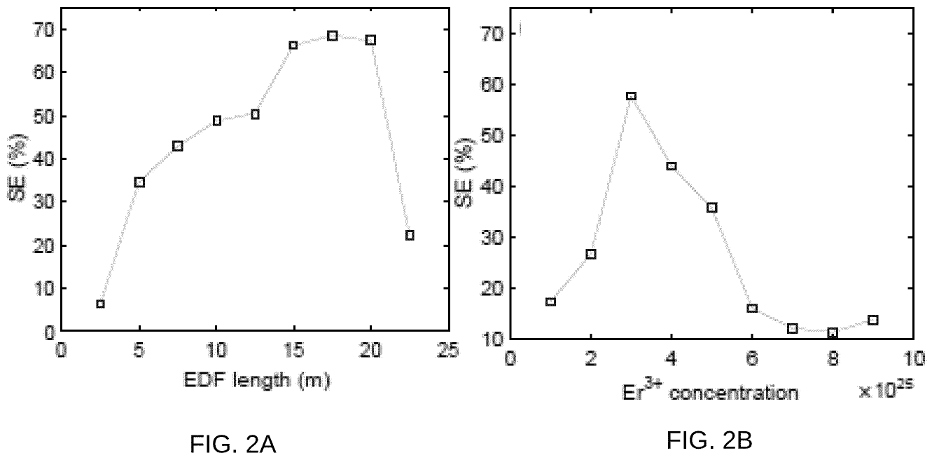

Firstly, by keeping the 1.48 μm pump power, Er³⁺ concentration, and output coupling ratio of first cavity fixed at 5 W, 40×10²⁴ m⁻³, and 10%, respectively, we vary the EDF length in steps. The output coupling ratio of 10% means that about 10% of the output power is transferred to the second cavity, and about 90% of the power is retained in the first cavity. The different EDF lengths result in different SE values as shown in FIG. 2A. It may be observed from FIG. 2A that the highest SE value is equal to about 68.5% for the EDF length of about 17.5 m. Therefore, EDF length of about 17.5 m is the optimized length which gives the highest SE, for all other parameters being fixed as mentioned above. Similarly, by keeping the 1.48 μm pump power, EDF length, and output coupling ratio of first cavity fixed at 5 W, 17.5 m, and 10% respectively, we vary the concentration of Er³⁺ ions in steps. The different values of Er³⁴ concentrations result in different SE values as shown in FIG. 2B. It may be observed from FIG. 2B that the highest SE value is equal to about 57.7% for Er³⁺ concentrations of about 30×10²⁴ m⁻³. Therefore, Er³⁺ concentration of about 30×10²⁴ m⁻³ turns out to be the optimized concentration which gives the highest SE, for all other parameters being fixed as described above. The tunable optical filter (TOF1) of the first cavity has been tuned at 1.62 μm while optimizing the EDF length and Er³⁺ concentration mentioned above.

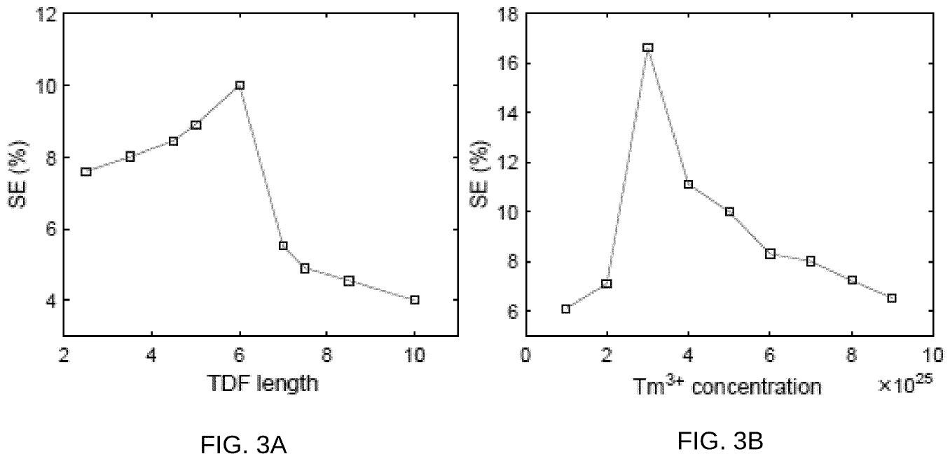

Now we proceed with the optimization of the second cavity. By keeping the Tm³⁺ concentration and an output coupling ratio of second cavity fixed at 50×10²⁴ m⁻³ and 10% respectively (i.e. about 10% of the output power goes to the Holmium-dopes amplifier, while about 90% of the power is retained in the second cavity), and while the second cavity being connected with first cavity which has been already optimized, we vary the TDF length in steps. The different TDF lengths result in different SE values as shown in FIG. 3A. It may be observed from FIG. 3A that the highest SE value is equal to about 10% for the TDF length of about 6 m. Therefore, the TDF length of about 6 m is the optimized length which gives the highest SE, for all other parameters being fixed as mentioned above. Similarly, by keeping the TDF length and the output coupling ratio of second cavity fixed at about 6 m and about 10% respectively, we vary the Tm³⁺ concentration in steps. The different values of Tm³⁺ concentration result in different SE values as shown in FIG. 3B. It may be observed from FIG. 3B that the highest SE value is equal to about 17% for Tm³⁺ concentration of about 30×10²⁴ m⁻³. Therefore, Tm³⁺ concentration of 30×10²⁴ m⁻³ turn out to be the optimized concentration which gives the highest SE, for all other parameters being fixed as mentioned above. The tunable optical filter (TOF2) of the second cavity has been tuned at 1.95 μm while optimizing the TDF length and Tm³⁺ concentration mentioned above.

HDFA with Proposed Pumping Scheme

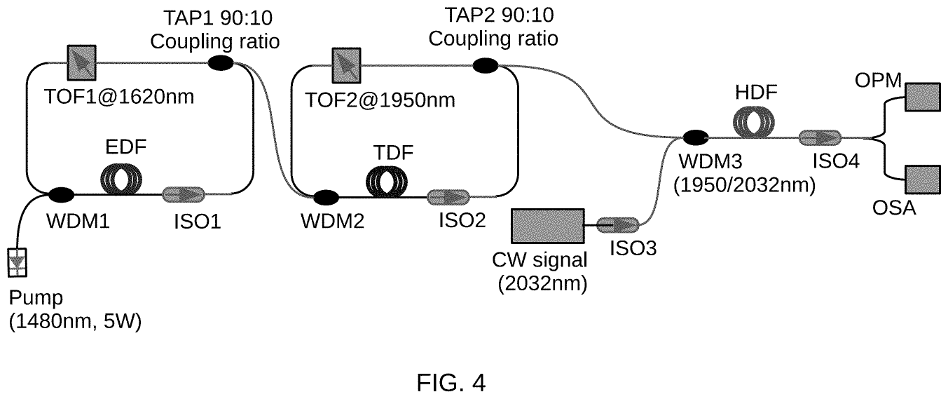

FIG. 4 shows the HDFA of the embodiments of the present invention with the proposed novel pumping scheme based on cascaded cavities of EDF and TDF for pumping the HDF.

The first cavity (also to be referred to as a first stage, or preceding stage) of the proposed cascaded design has a first wavelength division multiplexer WDM1 used to couple 1.48 μm pump generating 5 W power with EDF, an isolator ISO1 providing the unidirectional operation to prevent any lasing back reflection, a 90:10 optical coupler passing 10% of the output power to the second cavity, and a TOF1. The TOF1 is a transmission type optical bandpass filter (OBPF) whose center wavelength may be tuned within 1.535-1.625 μm wavelength range. The TOF1 has an insertion and reflection loss of 0 and 65 dB, respectively. The transfer function of TOF1 is given by the following equation:

T(f)=10^{-IL/20}H(f) (16)

where, T(f) is a filter transmission, H(f) is the transfer function, and IL is insertion loss. Similar TOFs, for example, having a tuning range around 60 nm, 85 nm, 110 nm, 120 nm, etc., are available on market and may be found at: http://www.wlphotonics.com/products/Tunable_Optical_Filters.html.

The first cavity is created using a circulating loop made of the EDF, a first tunable optical; filter TOF1, isolator ISO1, and a TAP1 or an optical coupler with 90/10 ratio to output the lased signal. The pump generates a broadband ASE signal in the EDF, which is filtered by the TOF1 tuned at 1.62 μm and passed again to the EDF. The selected band of the ASE gets amplified and circulates multiple times through the TOF1 and the EDF. As a result, a 1.62 μm CW laser is created, which is tapped at the coupler TAP1 and passed to the second cavity (also to be referred to as a second stage, or succeeding stage) to pump the TDF.

The second cavity has a second wavelength division multiplexer WDM2 used to couple 1.62 μm pump (the output from the first cavity) with the TDF, an isolator ISO2 ensuring the unidirectional operation to prevent any lasing back reflection, a second 90:10 optical coupler TAP2, and a second tunable optical filter TOF2. The 1.62 μm CW laser is used to pump a piece of TDF to create a 1.95 μm CW laser in the second cavity similar to that discussed above with regard to creating the 1.62 μm CW laser in the first cavity.

Finally, the HDF is pumped using the 1.95 μm CW laser, the output from the second cavity.

The Ho³⁺ ions are excited from ground energy state to higher energy states by pumping the HDF by 1.95 μm CW laser. The photons of the input signal to the HDFA that is to be amplified having a wavelength of 2.032 μm (CW Signal 2032 nm in FIG. 4) interact with the excited Ho³⁺ ions. This results in the increase in energy of the input signal in the form of supplementary photons that are released as a result of stimulated emission of excited Ho³⁺ ions having identical phase and frequency to the photons of the input signal.

The input CW signal at 2.032 μm passes through a third isolator ISO3, and supplied to a third wavelength division multiplexer WDM3 along with the pump from the 1.95 μm CW laser (output from the second cavity), before entering the HDF.

The output from the HDF passes through a fourth isolator ISO4, followed by being measured by an Optical Power Meter (OPM) and Optical Spectrum Analyzer (OSA).

The tuning of the first and second cavities has been performed considering the optimized parameters as discussed above.

The center wavelength of the TOF1 in the first cavity has been tuned in 1.535-1.625 μm wavelength range, and lasing power has been measured with the help of a first optical spectrum analyzer (not shown for the first cavity) connected with the optical coupler TAP1.

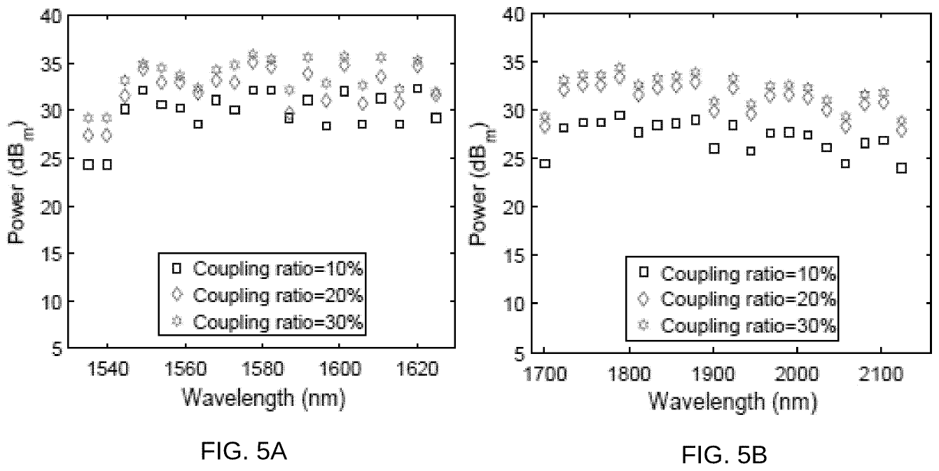

FIG. 5A shows a dependence of the output power from the first cavity (the lasing power of the first cavity) versus the center wavelength of the first tunable optical filter TOF1 (which determine a lasing wavelength of the first cavity), for output coupling ratios between the first and second cavities of 10%, 20%, and 30% respectively.

Similarly, the center wavelength of the second tunable optical filter TOF2 in the second cavity has been tuned in 1.7-2.125 μm wavelength range, while being connected with first cavity, and the lasing power (output power from the second cavity) has been measured with the help of another optical spectrum analyzer (not shown for the second cavity) connected with the second optical coupler TAP2.

FIG. 5B shows a dependence of the output power from the second cavity (the lasing power of the second cavity) versus the center wavelength of the TOF2 (which determines a lasing wavelength of the second cavity), for output coupling ratios between the second cavity and the HDFA of 10%, 20%, and 30% respectively.

FIGS. 5A and 5B show that the first cavity and the second cavity may be tuned within 1.535-1.625 μm and 1.7-2.125 μm wavelength ranges, respectively.

Also, it may be observed that the output power, or lasing power, from the first cavity increases with the increased coupling ratio between the first and second cavities, over the entire tuning band of the first cavity, i.e., the output power for 30% coupling ratio is slightly higher than the output power for the 20% coupling ratio, which in turn is higher than the output power for the 10% coupling ratio, as illustrated in FIG. 5A.

Similar results are also applicable to the output power, or lasing power, from the second cavity, which also increases over the entire tuning band of the second cavity with the increased coupling ratio between the second cavity and the HDFA, as illustrated in FIG. 5B.

Although both cavities are widely tunable as shown in FIGS. 5A and 5B, the lasing outputs at 1.62 μm and 1.95 μm become of particular significance because of their correspondence to respective absorption spectra of the TDF and HDF, for respective pumping the TDF and HDF.

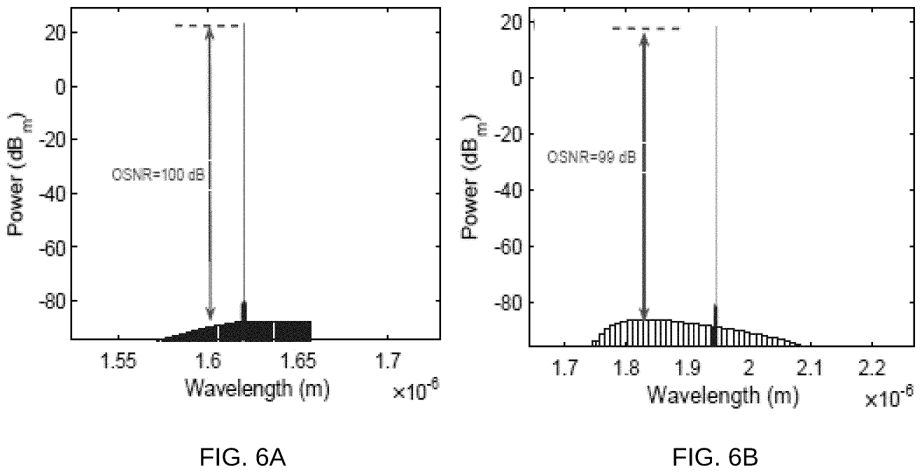

FIG. 6A shows an output power, or lasing power, from the first cavity versus a lasing wavelength around 1.62 μm, for the output coupling ratio of 20% between the first and second cavities.

FIG. 6B shows an output power, or lasing power, from the second cavity versus a lasing wavelength around 1.95 μm, for the output coupling ratio of 20% between the second cavity and the HDFA.

Various parameters used in our simulations are summarized in Table 2 below, which are similar to the commercially available optical components.

TABLE 2
Simulation Parameters

| Parameter | Value |
|---|---|
| Pump power | 5 w |
| Pump wavelength | 1.48 μm |
| Core radius of EDF, TDF, HDF | 2.25 μm, 2.25 μm, 1.3 μm |
| Doping radius of EDF, TDF, and HDF | 1.2 μm, 1.3 μm, 1.3 μm |
| Numerical aperture of EDF, TDF, HDF | 0.26, 0.3, 0.3 |
| Bandwidth of TOFs | 0.01 nm |
| Insertion and return losses of TOFs | 0 and 65 dB |
| Cross relaxation coefficient of HDF (K₂₁₀₁) | 2 × 10⁻²⁴ m⁻³ s⁻¹ |
| Cross relaxation coeflicient of HDF (K₁₀₁₂) | 40 × 10⁻²⁴ m⁻³ s^{-l} |
| Homogeneous upconversion coefficient of | 0.78 × 10⁻²¹ m⁻³ s⁻¹ |
| HDF (K₃₁₀₁) | |
| Homogeneous upconversion coefficient of | 2.3 × 10⁻²⁴ m⁻³ s⁻¹ |
| HDF (K₁₀₁₃) | |
| Ions per cluster | 2 |

### Results and Discussion

We have optimized the HDF length and doping concentration of Ho³⁺ to efficiently operate the HDFA for amplification of optical signals in the 2 μm wavelength range.

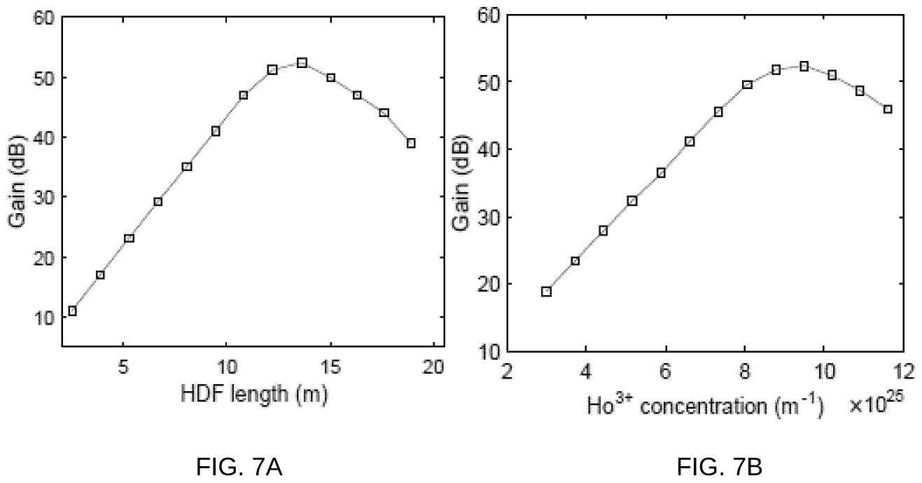

FIG. 7A shows a dependence of the gain of the HDFA versus length of the HDFA, for an input signal at 2.032 μm having power of −30 dBm, the doping concentration of Ho³⁺ ions at 90×10²⁴ m⁻³, while an output coupling ratio between the first and second cavities adjusted so that to provide a power of about 2 W for the 1.95 μm CW laser. The length of the HDF has been varied, and its effect on the gain of the HDFA has been observed for the above noted parameters of the HDFA.

It may be observed that the HDFA amplifier shows the highest gain of about 52 dB for about 13.6 m length of the HDF. A decrease in the gain has been noticed at further increasing the length of the HDF, which may be attributed to a decrease in population inversion (PI), as described for example in J. Mirza, S. Ghafoor, N. Habib, F. Kanwal, and K. K. Qureshi, “Performance evaluation of Praseodymium doped fiber amplifiers,” Optical Review, vol. 28, no. 6, pp. 611-618, 2021. and S. Mukhtar, K. N. Aliyu, and K. K. Qureshi, “Performance 295 evaluation of Er3,/Yb3, codoped fiber amplifier,” Microwave and Optical Technology Letters, vol. 62, no. 6, pp. 2243-2247, 2020.

Therefore, the length of 13.6 m has been considered as the optimized length which yields the highest gain, for other parameters of the HDFA being fixed as mentioned above.

FIG. 7B shows a dependence of the gain of the HDFA versus the doping concentration of Ho³⁺ ions, for the HDF length of 13.6 m, and the input signal at 2.032 μm having power of −30 dBm, while an output coupling ratio between the first and second cavities being adjusted so that to provide a power of about 2 W for 1.95 μm CW laser.

Similarly, the doping concentration of Ho³⁺ ions has been varied, and evolution of the gain of the HDFA has been observed for the optimized HDF length and other parameters of the HDFA being fixed as mentioned above.

As follows from FIG. 7B, the HDFA amplifier shows the highest gain of about 52.5 dB for doping concentration of about 95×10²⁴ m⁻³, which turns out to be the optimal concentration of Ho³⁺ ions, for other parameters of the HDFA being fixed as mentioned above.

A decreasing trend in gain has been observed after further increasing the doping concentration, which is due to initiation of clustering effect, as described for example in J. Wang, N. Bae, S. B. Lee, and K. Lee, “Effects of ion clustering and excited state absorption on the performance of Ho-doped fiber lasers,” Optics Express, vol. 27, no. 10, pp. 14283-14297, 2019. and M. Z. Amin, and K. K. Qureshi, “Investigation of clustering effects on Erbium-doped fiber laser performance,” Chinese Optics Letters, vol. 15, no. 1, pp. 010601-010606, 2017.

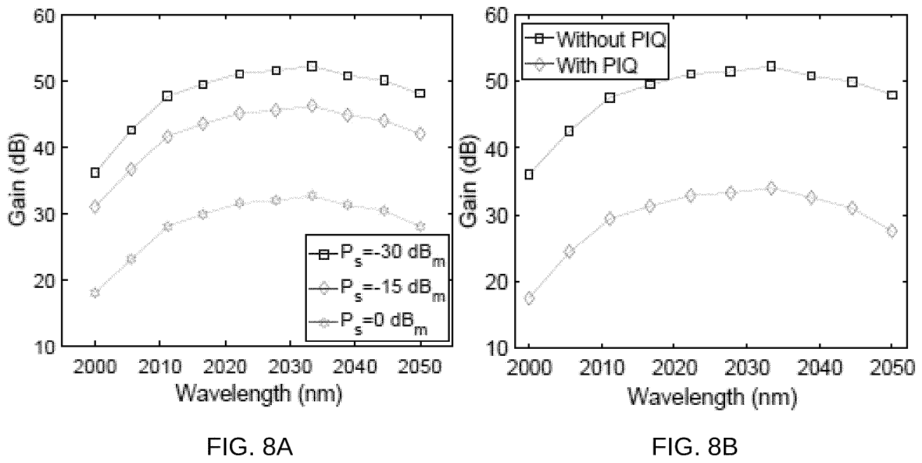

FIG. 8A shows a dependence of the gain of the HDFA versus a wavelength of the input signal, for different powers of the input signal and fixed optimal length of the HDF length of about 13.6 m and a doping concentration of Ho³⁺ ions of about 95×10²⁴ m⁻³.

It may be observed from FIG. 8A that the highest gain of the HDFA of about 52.5 dB is observed for the input signal wavelength of 2.032 μm, the pump power of 2 W, and the input signal power of −30 dBm, without considering the Pair-Induced Quenching (PIQ), the PIQ being caused by clustering of the ions in the doped-fiber core.

FIG. 8B shows a dependence of the gain of the HDFA versus wavelength of the input signal with and without PIQ (Pair-Induced Quenching), for the pump power of 2 W, the input signal power of −30 dBm, the length of the HDF of about 13.6 m, and a doping concentration of Ho³⁺ ions of about 95×10²⁴ m⁻³. As follows from FIG. 8B, a penalty of about 18.5 dB has been observed in the gain of the HDFA at 2.032 μm with the PIQ in comparison with the gain without PIQ.

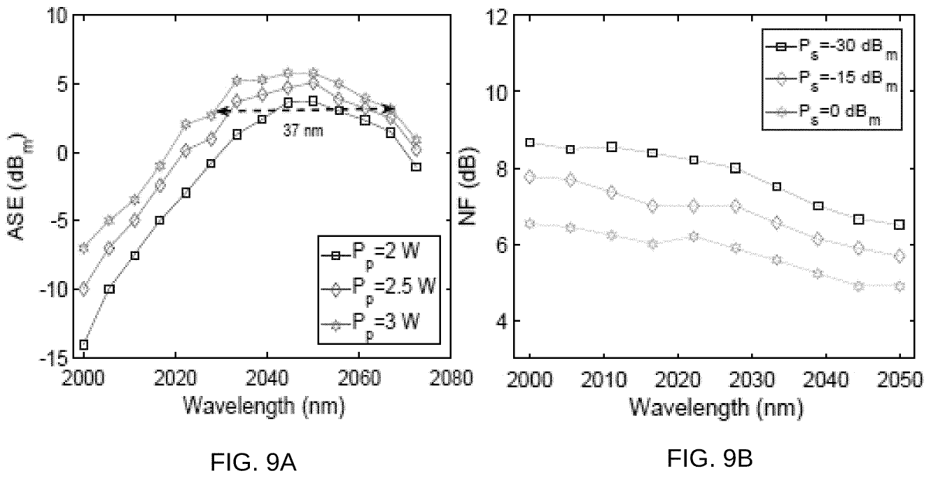

FIG. 9A shows a dependence of the ASE versus a wavelength of the input signal for various pump powers, for an input signal power of −30 dBm at the optimized HDF length of about 13.6 m, and a doping concentration of Ho³⁺ ions of about 95×10²⁴ m⁻³.

It may be observed that the peak ASE of about 6 dBm is obtained at the pump power of about 3 W, and the input signal power of about −30 dBm, for the wavelength of the input signal of about 2.044 μm. It may be also seen that the ASE shows a decreasing tendency for longer wavelengths, which is due to lower absorption of pump photons resulting into poor PI as shown in FIG. 9A, as described for example in J. Mirza, S. Ghafoor, N. Habib, F. Kanwal, and K. K. Qureshi, “Performance evaluation of Praseodymium doped fiber amplifiers,” Optical Review, vol. 28, no. 6, pp. 611-618, 2021.

Moreover, 3 dB ASE bandwidth of about 37 nm is obtained at 3 W pump power. During the process of amplification with optical amplifiers, ASE noise generates as a result of spontaneously emitted photons. The photons accumulate with the signal photons and decrease the optical signal-to-noise-ratio (OSNR) of the amplified signal. ASE noise increases sharply for weak input signals. Therefore, the noise figure (NF), or noise level, is a convenient indicator to judge the efficiency of an optical amplifier.

FIG. 9B shows a dependence of the NF versus a wavelength of the input signal, for different powers of the input signal of 0 dBm, −15 dBm and −30 dBm respectively, and the pump power of 2 W, the HDF length of about 13.6 m, and the doping concentration of Ho³⁺ ions of about 95×10²⁴ m.

It may be observed that a NF of around 5.5 dB is observed for the input signal wavelength of 2.032 μm, and the pump and input signal powers of 2 W and 0 dBm, respectively. Similarly, the NF becomes 7.5 dB for the input signal wavelength of 2.032 μm, and the pump and input signal powers of 2 W and −30 dBm, respectively.

### CONCLUSION

Thus, an efficient and cost-effective Holmium-doped fiber amplifier has been described, with efficient and low-cost cascaded fiber laser pumping based on cascaded cavities of Erbium-doped fiber and Thulium-doped fiber to pump the Holmium-doped fiber.

The first cavity uses a commercially available 1.48 μm laser of 5 W to pump the EDF to create a 1.62 μm CW laser, which is used to pump the TDF in second cavity to create a 1.95 μm CW laser used for pumping the HDF. A peak small-signal gain of around 52.5 has been obtained for an input signal power of −30 dBm at 2.032 μm. A noise figure of around 5.5 dB has been observed for an input signal power of 0 dBm at 2.032 μm. The impact of PIQ on small-signal gain of the HDFA is also evaluated. A penalty of 18.5 dB has been observed in gain of HDFA at 2.032 μm.

Although methods and systems of the embodiments of the present invention have been described with regard to the Holmium-doped fiber amplifier, it is understood that similar principles may be also applied to other fiber amplifiers doped with other rare-earth elements such as Erbium, Thulium, Ytterbium, Praseodymium, as long as (1) an emission spectrum of a preceding cascaded stage at least partly corresponds to an absorption spectrum of the succeeding cascaded stage, and the cascaded stages are staggered so that (2) the emission spectrum of the last cascaded stage at least partly corresponds to the absorption spectrum of the rare-earth-doped fiber in question.

Erbium-doped fibers may be pumped using laser diodes at wavelengths in the proximity of either 980 nm or 1480 nm, which fit within EDF absorption spectrum. To achieve performance of the 980 nm laser diode similar to that of the 1480 nm laser diodes described above, longer EDF lengths are used and higher pumping powers are required. In an alternative embodiment of the present invention, 980 nm laser may be used to pump the EDF in the first cavity (first stage) to produce a CW laser at 1620 nm, which will be used to pump the TDF to produce a 1950 nm CW laser in the second cavity (second stage). The 1950 nm CW laser is used to pump the HDF to amplify signals in the 2 m wavelength range, which fit in the HDF emission spectrum.

It should be noted that methods and systems of the embodiments of the invention and data sets described above are not, in any sense, abstract or intangible.

Although specific embodiments of the invention have been described in detail, it should be understood that the described embodiments are intended to be illustrative and not restrictive. Various changes and modifications of the embodiments shown in the drawings and described in the specification may be made within the scope of the following claims without departing from the scope of the invention in its broader aspect.

### REFERENCES

1 J. Mirza, S. Ghafoor, N. Habib, F. Kanwal, and K. K. Qureshi, “Performance evaluation of Praseodymium doped fiber amplifiers,” Optical Review, vol. 28, no. 6, pp. 611-618, 2021.
2 J. Mirza, W. A. Imtiaz, A. J. Aljohani, A. Atieh, and S. Ghafoor, “Design and analysis of a 32×5 Gbps passive optical network employing FSO based protection at the distribution level,” Alexandria Engineering Journal, vol. 59, no. 6, pp. 4621-4631, 2020.
3 WDM Lightwave Systems.: https://www.fiberoptics4sale.com/blogs/wave-optics/wdm-lightwave-systems, 2021.
4 C. Lei, H. Feng, L. Wang, Y. Messaddeq, and S. Larochelle, “An extended L-band EDFA using C-band pump wavelength,” In OSA Optical Fiber Communication Conference, pp. W1C-2,2020.
5 J. Mirza, W. A. Imtiaz, A. J. Aljohani, S. Ghafoor, “A high bit rate free space optics based ring topology having carrier-less nodes,” IET Communication, vol. 15, no. 11, pp. 1530-1538 2021.
6 S. Mukhtar, K. N. Aliyu, and K. K. Qureshi, “Performance 295 evaluation of Er3,/Yb3, codoped fiber amplifier,” Microwave and Optical Technology Letters, vol. 62, no. 6, pp. 2243-2247, 2020.
7 R. E. Tench, W. Walasik, and J-M. Delavaux, “Novel Highly Efficient In-Band Pump Wavelengths for Medium Slope Efficiency Holmium-Doped Fiber Amplifiers,” Journal of Lightwave Technology, vol. 39, no. 11, pp. 3546-3552, 2021.
8 G. D. Spiers, R. T. Menzies, J. Jacob, L. E. Christensen, and E. V. Browell, “Atmospheric CO2 measurements with a 2 μm airborne laser absorption spectrometer employing coherent detection,” Applied Optics, vol. 50, no. 14, pp. 2098-2111, 2011.
9 J. Caron, and Y. Durand, “Operating wavelengths optimization for a spaceborne LIDAR measuring atmospheric CO2,” Applied Optics, vol. 48, no. 28, pp. 5413-5422, 2009.
10 M. U. Sadiq, H. Zhang, J. O'Callaghan, B. Roycroft, and A. Gocalinska, “40 Gb/s WDM transmission over 1.15-km HC-PBGF using an InP-based Mach-Zehnder modulator at 2 μm,” Journal of Lightwave Technology, vol. 34, no. 8, pp. 1706-1711, 2016.
11 H. Zhang, N. Kavanagh, Z. Li, J. Zhao, N. Ye, Y. Chen, and N. V. Wheeler, “100 Gbit/s WDM transmission at 2 μm: transmission studies in both low-loss hollow core photonic bandgap fiber and solid core fiber,” Optics Express, vol. 23, no. 4, pp. 4946-4951, 2015.
12 S. D. Jackson, A. Sabella, A. Hemming, S. Bennetts, and D. G. Lancaster, “High-power 83 W Holmium-doped silica fiber laser operating with high beam quality, “Optics Letters, vol. 32, no. 3, pp. 241-243, 2007.
13 V. A. Kamynin, S. A. Filatova, I. V. Zhluktova, and V. B. Tsvetkov, “Holmium-doped fiber amplifier in the spectral region 2-2.15 μm,” In IEEE International Conference Laser Optics (LO), pp. S1-17, 2016.
14 N. Simakov, Z. Li, Y. Jung, J. M. Daniel, P. Barua, P. C. Shardlow, and S. Liang, “High gain Holmium-doped fibre amplifiers,” Optics Express, vol. 24, no. 13, pp. 13946-13956, 2016.
15 N. Simakov, Z. Li, S. U. Alam, P. C. Shardlow, J. M. Daniel, D. Jain, and D. J. Richardson, “Holmium-doped fiber amplifier for optical communications at 2.05-2.13 μm, “In IEEE Optical Fiber Communications Conference and Exhibition (OFC), pp. 1-3, 2015.
16 R. E. Tench, C. Romano, J-M. Delavaux, T. Robin, B. Cadier, and A. Laurent, “All-polarization-maintaining one- and two-stage Holmium-doped Fiber Amplifiers at 2051 nm,” In OSA CLEO Applications and Technology, pp. JTh2A-132, 2018.
17 I. V. Zhluktova, V. A. Kamynin, and V. B. Tsvetkov, “Holmium fiber amplifier operating in the spectral range 2016-2200 nm,” In IEEE International Conference of Laser Optics (ICLO), pp. 115-117, 2018.
18 R. E. Tench, A. Amavigan, C. Romano, D. Traore, J-M. Delavaux, T. Robin, and P. Crochet, “3.5 W Broadband PM hybrid amplifier at 2051 nm with Holmium- and Thulium-Doped Single-Clad Fibers,” Journal of Lightware Technology, vol. 39, no. 5, pp-1471-1476, 2021.
19 W. Walasik, R. E. Tench, J-M. Delavaux, and E. Lallier, “2090 nm 200 W peak power 50 ns pulsed PM Ho-doped fiber amplifier pumped at 1860 nm.,” Journal of Lightwave Technology, Published online, 2021.
20 OptiSystem Overview: https://optiwave.com/optisystem-overview/.
21 Emission Cross Section.: https://fibercore.humaneticsgroup.com/services-support/fiberpaedia/e/emission-crosssection, 2021.
22 W. Yang, Y. Liu, L. Xiao, and Z. Yang, “Wavelength-tunable Erbium-doped fiber ring laser employing an acousto-optic filter,” Journal of lightwave technology, vol. 28, no. 1, pp. 118-122, 2010.
23 A. H. M. Husein, and F. I. El-Nahal, “Optimizing the Thulium doped fiber amplifier (TDFA) gain and noise figure for S-band 16×10 Gb/s WDM systems,” Optik, vol. 124, no. 19, pp. 4052-4057, 2013.
24 J. Wang, N. Bae, S. B. Lee, and K. Lee, “Effects of ion clustering and excited state absorption on the performance of Ho-doped fiber lasers,” Optics Express, vol. 27, no. 10, pp. 14283-14297, 2019.
25 J. Wang, D. Yeom, N. Simakov, A. Hemming, A. Carter, S. B. Lee, and K. Lee, “Numerical modeling of in-band pumped Ho-doped silica fiber lasers,” Journal of Lightwave Technology, vol. 36, no. 24, pp. 5863-5880, 2018.
26 Tunable optical filters.: http://www.wlphotonics.com/products/Tunable_Optical_Filters.html
27 M. Z. Amin, and K. K. Qureshi, “Investigation of clustering effects on Erbium-doped fiber laser performance,” Chinese Optics Letters, vol. 15, no. 1, pp. 010601-010606, 2017.

What is claimed is:

1. A Holmium-doped fiber amplifier (HDFA), comprising:
a Holmium-doped fiber (HDF); and
a cascaded pumping arrangement for the Holmium-doped fiber, comprising at least two cascaded pumping stages, wherein:
(1) an emission spectrum of a preceding cascaded pumping stage at least partly corresponds to an absorption spectrum of the succeeding cascaded pumping stage; and
(2) the cascaded pumping stages are staggered so that an emission spectrum of the last cascaded pumping stage at least partly corresponds to an absorption spectrum of the Holmium-doped fiber.

2. The Holmium-doped fiber amplifier of claim 1, wherein:
the preceding cascaded pumping stage comprises an Erbium-doped fiber (EDF) pumped at one of the 980 nm or 1480 nm, and emitting a first output signal at 1620 nm;
the succeeding cascaded pumping stage comprises a Thulium-doped fiber (TDF) pumped by the first output signal from the EDF at 1620 nm, and emitting a second output signal at 1950 nm; and
the second output signal from the TDF at 1950 nm is used to pump the HDF.

3. A cascaded pumping arrangement for a Holmium-doped fiber (HDF), comprising:
at least two cascaded pumping stages, wherein:
(1) an emission spectrum of a preceding cascaded pumping stage at least partly corresponds to an absorption spectrum of the succeeding cascaded pumping stage; and
(2) the cascaded pumping stages are staggered so that an emission spectrum of the last cascaded pumping stage at least partly corresponds to an absorption spectrum of the Holmium-doped fiber.

4. The cascaded pumping arrangement of claim 3, wherein:
the preceding cascaded pumping stage comprises an Erbium-doped fiber (EDF) pumped at one of the 980 nm or 1480 nm, and emitting a first output signal at 1620 nm;
the succeeding cascaded pumping stage comprises Thulium-doped fiber (TDF) pumped by the first output signal from the EDF at 1620 nm, and emitting a second output signal at 1950 nm; and
the second output signal from the TDF at 1950 nm is used to pump the HDF.
